(19) United States
(12) Patent Application Publication
(10) Pub. No.: US 2006/0035484 A1
(43) Pub. Date: Feb. 16, 2006

(54) Land grid array terminal having variable circuitry

(75) Inventor: Wen-Te Hsu, Taipei Hsien (TW)

Correspondence Address: BIRCH STEWART KOLASCH & BIRCH, PO BOX 747, FALLS CHURCH, VA, 22040-0747, US

(73) Assignee: Starlink Electronics Corp., Taipei Hsien (TW)

(21) Appl. No.: 10/958,335

(22) Filed: Oct. 6, 2004

(30) Foreign Application Priority Data
Aug. 10, 2004 (TW) 093212693

(51) Int. Cl. H01R 12/00

(52) U.S. Cl. 439/66

(57) ABSTRACT

A land grid array terminal is provided. The terminal includes a side plate, and two elastic arms respectively formed on the upper and lower portions of the side plate. At the central portion of the each elastic arm, a bend portion is formed protrusively facing towards each other. The terminal has a larger circuitry when it is not pressed. However, when the terminal is pressed, the bend portions of the elastic arms contact each other to form a shorter circuitry. This renders a shorter conducting circuitry and a better supporting strength.

### BACKGROUND OF THE INVENTION

1. Field of the Invention

The present invention relates generally to a land grid array terminal having a variable circuitry, and more particularly to a land grid array terminal that the elastic arm thereof forms a non-end portion contact when pressing both ends of the terminal, which renders a shorter conducting circuitry and a better supporting strength. 2. Prior Art

Land grid array (LGA) technique is gradually becoming a widely adopted standard in electronic industry. A conventional LGA terminal 70, as shown in FIG. 4, comprises a vertically disposed base 71. Two elastic arms 72, 73 are extensively formed on the upper end and the lower end of the base 71, respectively. The ends of the elastic arms 72, 73 extend outward, contacting an electronic device and a printed circuit board, respectively. In order to make better served elastic arms 72, 73, the two end portions of the base 71 and the ends of the elastic arms 72, 73 must be separated by some certain distance. This is disadvantageous for at least the following reasons:

(1) For considering the elastic properties, the elastic arms of the conventional terminal must be of certain length. When two ends of the elastic arms contact the electronic device and the printed circuit board, the conducting circuitry so defined becomes from the upper elastic arm through the base to the lower elastic arm, which is rather lengthy. The elongated conducting circuitry has a relatively larger resistance, which brings a negative effect to electrical conduction.

(2) Since the pivotal point of the conventional elastic arm is the base, the supporting strength thereof is often not strong enough when the elastic arm is pressed to a larger deformation.

(3) According to the above, when choosing the base as a pivotal point and at the same time, requiring the elastic arms to sustain a larger deformation, the elastic arm needs to have a longer length S2 counting from the vertical line L2. However, reducing the length of the elastic arm will reduce the depth h2 affordable for the elastic arm. (Normally, the depth h2 is approximately 0.27 mm.) The insufficient affordable depth of the terminal may result in an unstable electrical contact, especially when the electronic device is warped and deformed.

Referring to FIG. 5, a conventional terminal 80 disclosed in the U.S. Pat. No. 6,730,134 is illustrated. The conventional terminal 80 is roughly in a C-shape. The elastic arms 82, 83 are directly formed on the upper and lower portions of the central arch plate 81. The terminal 80 is disposed in the terminal hole 90. A protrusive portion 91 is formed on one side of the terminal hole 90, making the opening portion of the C-shape terminal facing the protrusive portion 91. The upper and the lower portions of the protrusive portion 91 thus lock the terminal 80 to be securely disposed in the terminal hole 90. However, the C-shape terminal 80 is disadvantageous in that the deformation of the terminal 80 can only reach to a depth h3 of 0.18 mm, which is insufficient for securing the electrical conductance.

### SUMMARY OF THE INVENTION

Therefore, the objective of the present invention is to provide a land grid array terminal that has stronger supporting strength, shorter conducting circuitry, and can afford larger elastic deformation.

In light of the above and other objectives, the terminal of the present invention includes a bend portion protrusively formed on the elastic arms of the terminal. When the elastic arms are pressed, the two bend portions of the elastic arms contact each other, resulting in a shorter conducting circuitry. In addition, the contact of the two bend portions forms a structural supporting point, which reduces the inclination angle of the elastic arms and supports a larger elastic deformation. This renders the terminal of the present invention being shorter in conducting circuitry and stronger in supporting strength.

### BRIEF DESCRIPTION OF THE DRAWINGS

FIG. 1 is a perspective view of a land grid array terminal of the present invention.

FIG. 2 is a side elevation of the terminal of the present invention.

FIG. 3 illustrates the terminal of the present invention in the in-use status.

FIG. 4 illustrates a conventional land grid array terminal.

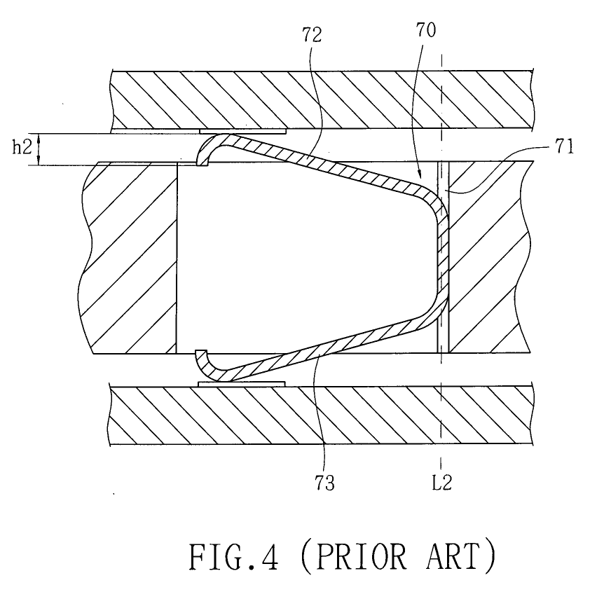

FIG. 5 illustrates another conventional land grid array terminal.

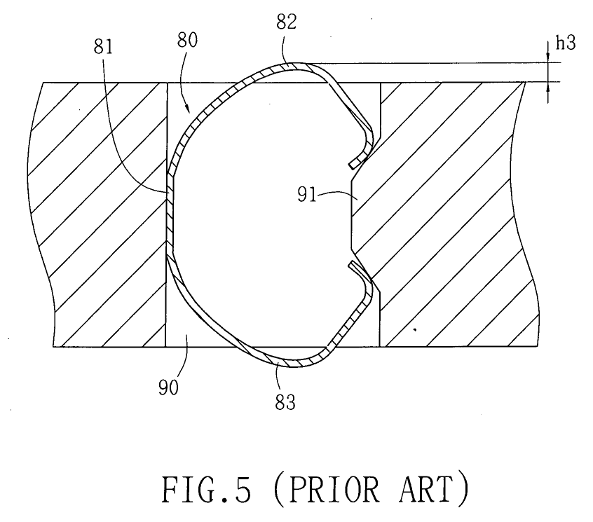

### DETAILED DESCRIPTION OF THE INVENTION

In order to better understanding the technical features of the present invention, detailed descriptions thereof are hereinafter provided by incorporating with the accompanying drawing.

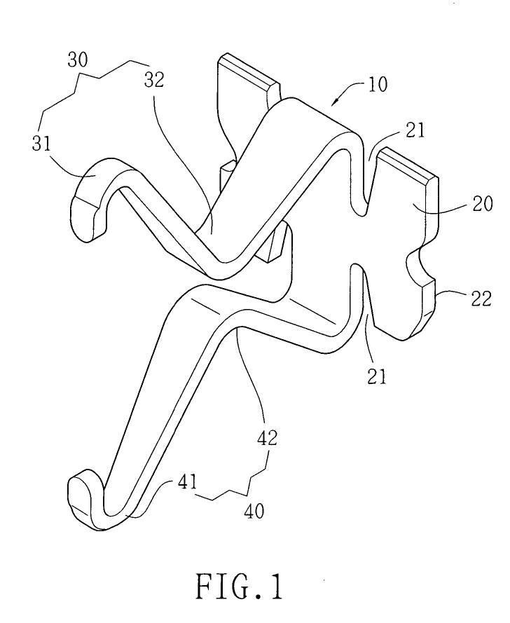

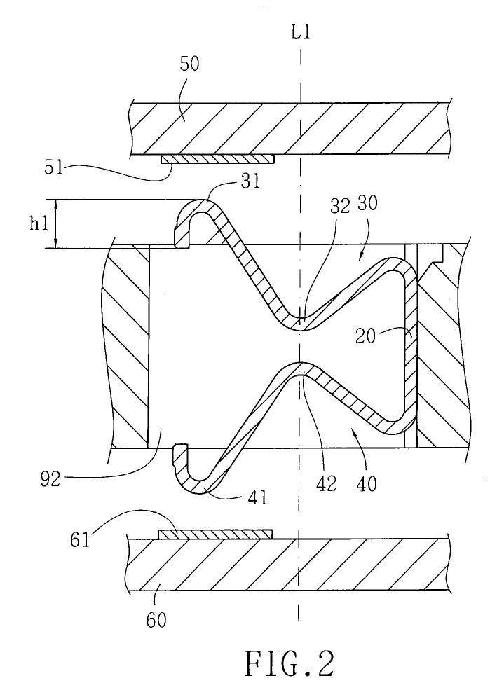

Referring to FIG. 1 and FIG. 2, the terminal 10 of the present invention is illustrated. The terminal 1 comprises a vertically disposed side plate 20. A barb 22 is formed at both sides of the side plate 20. Two elastic arms 30, 40 are respectively formed on the top portion and the bottom portion of the side plate 20. The elastic arms 30, 40 comprises contact portions 31, 41 respectively at the end portions thereof, and bend portions 32, 42 at the non-contact portions. In this particular embodiment, the bend portions 32, 42 are in a V-shape, while in other embodiments, the bend portions 32, 42 can be any arch shape equivalent to the V-shape as shown and described. In order to enhance the elastic properties of the elastic arms 30, 40, a plurality of concave grooves 21 is formed on the side plate 20 at the two sides of the end portions of the elastic arms 30, 40.

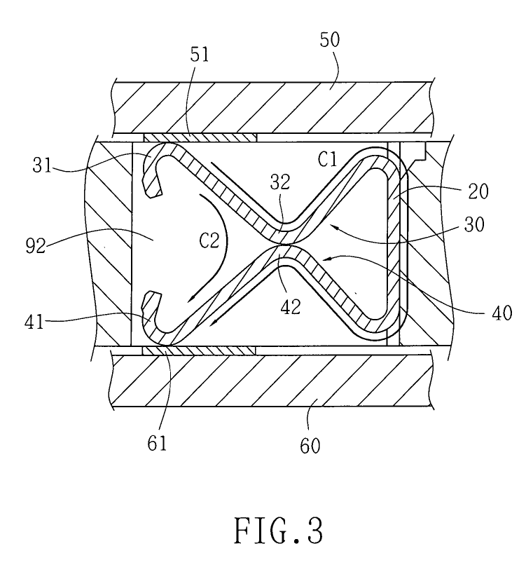

Referring to FIG. 1, FIG. 2 and FIG. 3, the terminal 10 of the present invention is disposed in the terminal hole 92, which is securely fastened therein by means of the barbs 22. The contact portions 31, 41 at the end of the upper and lower elastic arms 30, 40 obtrude the terminal hole 92. When pressing an electronic device 50 downward, the contact pad 51 of the electronic device 50 contacts the contact portion 31, while the contact pad 61 of the printed circuit board 60 contacts the other contact portion 41. The upper and lower elastic arms 30, 40 are thus pressed toward each other, rendering the protrusive bend portions 32, 42 contacting each other. The original conducting circuitry C1 requires a current flow from the upper elastic arm 30 through the side plate 20 to the lower elastic arm 40. However, since the protrusive bend portions 32, 42 contacts each other, the conducting circuitry C2 now requires a shorter current flow from the contact portion 31 of the elastic arm 30 through the upper bend portion 32 and the lower bend portion 42 to contact portion 41 of the elastic arm 40.

Therefore, the advantages of the present invention are summarized in the following:

(1) When the elastic arms are pressed, the bend portions contact each other, rendering a shorter conducting circuitry. This reduces the effective resistance of the circuitry and enhances the electrical conduction.

(2) On the other hand, the mutual contact of the bend portions forms a supporting point. The distance of the supporting point to the contact portion is shorter, thus having a stronger supporting strength. Therefore, the present invention provides a terminal that is highly deformable and strong in supporting strength.

(3) As shown in FIG. 2, when both of the V-shape bend portions 32, 42 of the terminal 10 contact each other, the elastic arms to the left hand side of the vertical line L1 is shorter in length. Therefore, a deeper protrusive depth can be provided. In addition, the protrusive width S1 in the horizontal direction is not increased. According to the measurement, the affordable effective elastic depth h1 of the terminal is 0.32 mm, which is much better than the conventional terminals.

Although a particular embodiment of the present invention has been described in detail for purposes of illustration, various modifications and alterations can be made without departing from the spirit and scope of the invention. Accordingly, the present invention is defined by the appended claims.

1. A land grid array terminal, comprising:
a side plate, and two elastic arms respectively formed on the upper and lower portions of the side plate, the elastic arms having a contact portion formed at the end portion thereof, which is characterized in that:
at least a bend portion is formed on one elastic arm protrusively facing towards the other elastic arm, whereby a shorter conducting circuitry is formed when the bend portion of one elastic arm contacts the other elastic arm.

2. The terminal as recited in claim 1, wherein both of the two elastic arms comprises a bend portion formed thereon, each bend portion being protrusively facing towards each other.

3. The terminal as recited in claim 1 or 2, wherein the bend portion is in a V-shape.

4. The terminal as recited in claim 3, wherein the bottom portion of the V-shape bend portion is in an arch shape.

5. The terminal as recited in claim 1, wherein a plurality of concave grooves is formed on the side plate at the two sides of the end portions of the elastic arms.
